(19) United States
(12) Patent Application Publication
(10) Pub. No.: US 2017/0356293 A1
(43) Pub. Date: Dec. 14, 2017

(54) Balancing weight for a rotor blade of a turbine stage

(71) Applicant: MTU Aero Engines AG, Muenchen (DE)

(72) Inventor: Marcus Woehler, Inning am Ammersee (DE)

(21) Appl. No.: 15/617,112

(22) Filed: Jun. 8, 2017

(30) Foreign Application Priority Data
Jun. 14, 2016 (DE) 102016210454.3

(51) Int. Cl. F01D 5/02

(52) U.S. Cl. CPC F01D 5/027; F05D 2240/303; F05D 2220/32; F05D 2230/60; F05D 2240/304; F05D 2260/30

(57) ABSTRACT

A balancing weight for a rotor blade of a turbine stage of a gas turbine, in particular of an aircraft gas turbine; including a first bent fastening portion that is couplable to an axial leading edge of a shroud of the rotor blade, a second fastening portion that is couplable to an axial trailing edge of the shroud, and a middle portion that joins the first fastening portion and the second fastening portion; the second fastening portion assumes a first position relative to the first fastening portion prior to a mounting of the balancing weight on the rotor blade, and a second position relative to the first fastening portion subsequently to the mounting of the balancing weight on the rotor blade; in the second relative position, the middle portion or/and the second fastening portion being deformed, in particular plastically deformed.

This claims the benefit of German Patent Application DE 102016210454.3, filed Jun. 14, 2016 and hereby incorporated by reference herein.

The present invention relates to a balancing weight for a rotor blade of a turbine stage of a gas turbine, in particular of an aircraft gas turbine; including a first bent fastening portion that is couplable to an axial leading edge of a shroud of the rotor blade, a second fastening portion that is couplable to an axial trailing edge of the shroud, and a middle portion that joins the first fastening portion and the second fastening portion. In this instance, the wording “balancing weight for a rotor blade” means in particular that the balancing weight is suited for attachment to the rotor blade.

### SUMMARY OF THE INVENTION

Directional indications, such as “axial,” “radial” and “circumferential” are to be basically understood as relative to the machine axis or the main flow direction of the gas turbine, unless otherwise explicitly or implicitly derived from the context.

It is generally known to provide a balancing weight in the region of two adjacent shroud segments, the balancing weight extending over both shroud segments. The disadvantage of such a balancing weight configuration is that the two adjacent shroud segments are subject to relative movements, hereby also altering the position of the balancing weight and producing unfavorable stress ratios, or even loosening an attachment of the balancing weight over time, which can disadvantageously lead to fretting.

Generally, attaching balancing weights is also a complicated operational step because it requires introducing tools into the intermediate spaces between the rotor blades of a rotor blade ring in order to fasten the balancing weight. There is a risk of damage to the rotor blades.

It is an object of the present invention to provide a balancing weight that will overcome the above-mentioned disadvantages.

To achieve this objective, it is provided that the second fastening portion assume a first position relative to the first fastening portion prior to a mounting of the balancing weight on the rotor blade, and a second position relative to the first fastening portion following the mounting of the balancing weight on the rotor blade; in the second relative position, the middle portion or/and the second fastening portion being deformed, in particular plastically deformed.

Thus, the balancing weight is configured to allow the second fastening portion to be deformed relative to the first bent fastening portion from an initial position into a mounting position. The initial position (first relative position) thereby connotes a state of the balancing weight prior to the attachment thereof to the rotor blade shroud. In the mounting position, where the first bent portion is coupled to the leading axial shroud edge, the coupling between the second fastening portion and the shroud segment, in particular to the axially trailing shroud edge thereof, is accomplished by the deformation of the second fastening portion, respectively the middle portion.

The first fastening portion may be bent to allow it to be hooked onto the axial leading edge of the shroud and, in the hooked-on state, be secured to the shroud at least in the radial and circumferential directions. The first fastening portion is bent in a hook or U-shape, for example, or in another suitable way that makes possible the desired hooking-on that may also be understood as a type of interlocking connection. It should be appreciated that the term “hooking on” is not necessarily to be understood as the first fastening portion resting under the force of gravity in a hanging manner, rather such a hooking on of the bent first fastening portion may also be realized along the axial direction. The hooking on may also be understood as bringing into engagement.

The balancing weight may also be in the form of a strip-type metal element; the strip-type metal element having a plurality of bent regions along its extent from a first end to a second end. The first end may thereby be an unattached end of the first fastening portion, and the second end an unattached end of the second fastening portion. As already explained above, at least the fastening portion has one or a plurality of bent regions or portions. However, in the first or/and the second relative position, the second fastening portion may also have bent regions or portions. In particular, the second fastening portion may have bent regions that, themselves, are not deformed at the transition from the first relative position to the second relative position.

In relation to the first relative position of the second fastening portion, the middle portion may have a torsion portion where the strip-type metal element is twisted about the longitudinal axis thereof in a first rotational direction, in particular by about 90°. In other words, it may be said that the middle portion is wound by about 90° along the longitudinal axis of the strip.

Moreover, in relation to the second relative position of the second fastening portion, the middle portion may be twisted about the longitudinal axis of the strip in a second rotational direction opposite the first rotational direction in a way that essentially flattens the torsion portion. Thus, in the second relative position, the twisted torsion region is untwisted, so that there is no longer a turn in the middle portion. When the middle portion is again essentially in a flat form in the second relative position of the second fastening portion, it may engage on a radial inner side of the shroud segment such that it extends on the shroud segment along a side of the respective rotor blade.

The second fastening portion may have a plurality of elongated openings that are spaced at regular intervals, starting from an unattached end of the second fastening portion. In addition, the elongated openings may essentially extend here parallel to a bending axis, about which the second fastening portion is plastically deformed in the second relative position. The elongated openings are used, in particular, to facilitate the deformation or bending of the second fastening portion, since only a small amount of material of the second fastening portion to the side of the elongated openings needs to be deformed.

A blade coupling portion, which is configured to be couplable to a leading edge of the rotor blade, may adjoin the first fastening portion. Such a blade coupling portion is thereby used, in particular, to axially secure the balancing weight.

Another aspect of the present invention relates to a rotor blade ring of a turbine stage of a gas turbine, in particular of an aircraft gas turbine, having a plurality of circumferentially adjacently disposed rotor blades which, at the radially outer ends thereof, have a respective shroud segment having an axially leading shroud edge and an axially trailing shroud edge; a balancing weight being disposed on at least one rotor blade on the shroud segment thereof, preferably a balancing weight of the previously described type; the balancing weight including a first bent fastening portion, which is coupled to the axially leading shroud edge, a second fastening portion that is coupled to the axially trailing shroud edge, and a middle portion that joins the first bent fastening portion and the second fastening portion. The second fastening portion thereby assumes a first position relative to the first fastening portion prior to a mounting of the balancing weight on the rotor blade, and a second position relative to the first fastening portion subsequently to the mounting of the balancing weight on the rotor blade; in the second relative position, the middle portion or/and the second fastening portion being deformed, in particular plastically deformed. The rotor blade ring preferably includes a multiplicity of individual blades or is even exclusively formed therefrom; a balancing weight of the type under discussion preferably being in contact with only one individual blade, not, however, with a plurality thereof. In particular, the balancing weight preferably does not extend past a shroud gap between two circumferentially adjacent individual blades. Here, the advantage is derived that the balancing weight is able to be reliably held even when different creep elongations of the individual blades occur during operation.

Furthermore, the balancing weight is preferably configured to be mountable without contacting the trailing edge of a blade in the rotor blade ring associated therewith. In applications in the high-temperature region, in particular, relatively brittle materials, such as a TiAl-based material, are preferably used as a blade base material. Since the trailing edge of such a blade is generally relatively thin compared to the leading edge, it is correspondingly sensitive to load effects. Because the balancing weight according to the present invention is not braced against the sensitive trailing edge, damage thereto may be reliably prevented. Instead, the plastic deformation of the inventive balancing weight at the axial rear end thereof during mounting allows it to be interlockingly coupled to the shroud of the rotor blade. The shroud preferably features a setback in the axial direction at the coupling location provided for that purpose. On the second fastening portion thereof, the balancing weight may have another unattached end, which, in the installed state of the balancing weight, preferably extends circumferentially on the side of the shroud facing away from the blade, respectively the airfoil portion, toward the trailing edge of the blade, respectively the airfoil portion. Thus, viewed circumferentially, the mass of the balancing weight may be positioned relatively closely to the blade, respectively the airfoil portion. This has the advantage of making it possible to reduce unwanted deformations of the shroud when the centrifugal forces act on the balancing weight and the shroud.

Finally, the present invention also relates to a method for attaching a balancing weight to a shroud segment of a rotor blade of a rotor blade ring of a turbine stage of a gas turbine that includes the following steps:
providing a balancing weight having a first bent fastening portion, a second fastening portion, and a middle portion that joins the first fastening portion and the second fastening portion;
introducing the first bent fastening portion and the middle portion between two adjacent rotor blades of the rotor blade ring in a flow direction opposite that of the gas turbine;
positioning the first bent fastening portion on an axially leading edge of the shroud segment and coupling it thereto, in particular by hooking on the first bent fastening portion;
deforming the second fastening portion or/and the middle portion, allowing the second fastening portion to be coupled to an axially trailing edge of the shroud segment.

### BRIEF DESCRIPTION OF THE DRAWINGS

The present invention will be explained exemplarily in the following with reference to the enclosed figures and without being limited thereto.

FIG. 1 is a simplified, schematic, perspective view, axially from the front, of a rotor blade portion having the associated shroud and a balancing weight attached thereto.

FIG. 2 is a simplified, schematic, perspective view of the balancing weight from FIG. 1, prior to installation on the or a rotor blade.

FIG. 3 is a simplified, schematic, perspective view, axially from the rear, of the rotor blade portion of FIG. 1, including the associated shroud and the balancing weight attached thereto.

FIG. 4 is a simplified, schematic, perspective view, axially from the rear, of a rotor blade portion having the associated shroud and an alternative balancing weight attached thereto.

FIG. 5 is a simplified, schematic, perspective view, axially from the rear, of a rotor blade portion having the associated shroud and an alternative balancing weight attached thereto.

FIG. 6 is a simplified, schematic, perspective view, axially from the front, of a rotor blade portion having the associated shroud and a balancing weight attached thereto.

FIG. 7 is an axially rear fastening portion of a balancing weight.

FIG. 8 is a type of perspective part sectional view of a balancing weight on a rotor blade, the balancing weight having an axially rear fastening portion in correspondence with FIG. 6.

### DETAILED DESCRIPTION

The representations selected in the figures are rather sketch-like and are intended to illustrate the design of balancing weights. The drawings do not have the quality of dimensionally correct technical drawings. This relates, in particular, to certain perspective distortions or inaccuracies in the lines.

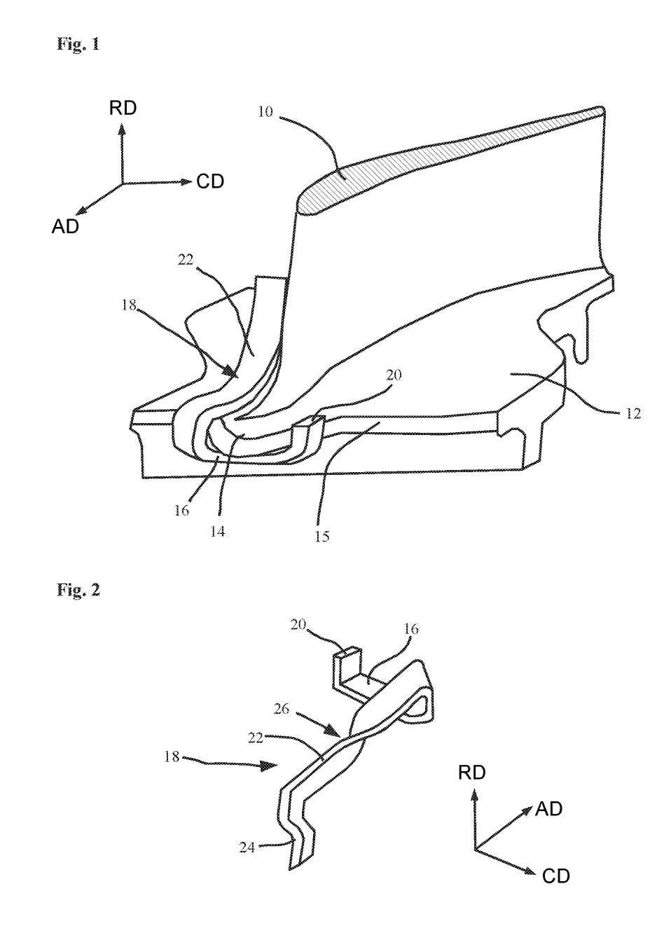

In a simplified and schematic representation, FIG. 1 shows a radially outer portion of a rotor blade 10 and a shroud 12 associated therewith. Shroud 12 features an axial projection 14. Projection 14 is configured in the area of axial leading edge 15 of rotor blade 10. A first fastening portion 16 of a balancing weight 18 is hooked onto the radial outer side of projection 14. Starting from an unattached end 20, first fastening portion 16 is repeatedly bent, and then merges into a middle portion 22. Middle portion 22 extends along the shroud and along the suction side of rotor blade 10.

FIG. 2 shows balancing weight 18 of FIG. 1 in a simplified, perspective view. Besides the already mentioned first fastening portion 16 and middle portion 22 contiguous thereto, balancing weight 18 features a second fastening portion 24. In the installed state of balancing weight 18, second fastening portion 24 is situated axially to the rear in each particular case and is couplable to an axial trailing edge of a shroud. At 26, middle portion 22 is twisted along axial direction AD (longitudinal direction of strip-type middle portion 22), here, exemplarily by approximately 90°. This twisted region 26 may also be referred to as torsion region 26. Middle portion 22 essentially extends along axial direction AD. First fastening portion essentially extends along circumferential direction CD. Second fastening portion 24 essentially extends in radial direction RD. In the representation in FIG. 2, second fastening portion 24 is situated in a first position relative to first fastening portion 16. Second fastening portion 24 assumes this first relative position when the balancing weight is not yet fastened to the shroud of the rotor blade. Thus, FIG. 2 shows an uninstalled state of balancing weight 18. In other words, balancing weight 18 features the configuration shown in FIG. 2 prior to the mounting thereof on a rotor blade.

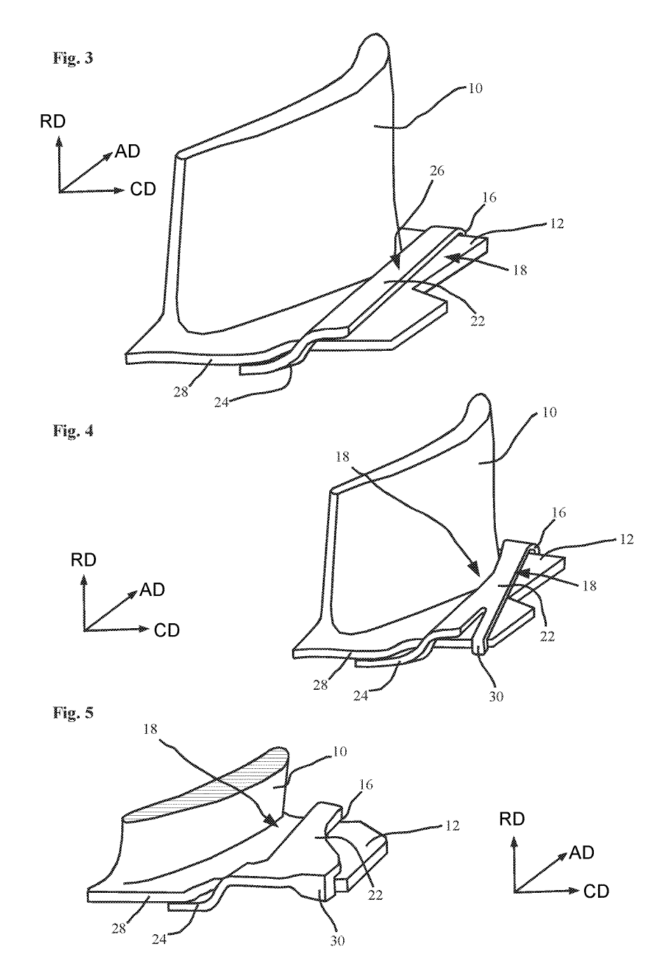

FIG. 3 shows rotor blade 10 of FIG. 1 in a simplified, perspective view, axially from the rear. In comparison to the state of FIG. 2 (uninstalled state of the balancing weight), middle portion 22 of balancing weight 18 no longer shows a twisted region 26. There is no twisting of middle portion 22 because second fastening portion 24 has been swiveled clockwise relative to the direction of view in FIG. 2 and FIG. 3. This swiveling or twisting moves second fastening portion 24 into a second position relative to first fastening portion 18 (not visible in FIG. 3). In this second relative position, second fastening portion 24 is coupled to an axial trailing edge 28 of shroud 12.

By considering FIG. 1 through 3 together, even the process of attaching a balancing weight 18 may be easily understood. A balancing weight 18 is axially introduced by first fastening portion 16 thereof between two rotor blades and, specifically, axially from the rear. First fastening portion 18 is then hooked onto axial leading edge 15 of shroud 12, in particular onto projection 14. Upon positioning of first fastening portion 18, middle portion 22 may be guided along shroud 12. Second fastening portion 24 is then still situated in the first position illustrated in FIG. 2 relative to first fastening portion 16. In the region of axial trailing edge 28 of shroud 12, second fastening portion 24 may then be grasped by a suitable tool and twisted accordingly. Twisted region 26 of middle portion (FIG. 2) is again opened, respectively middle portion 22 is again brought into an essentially torsion-free, respectively planar orientation (FIG. 3). Thus, a balancing weight of this kind may be readily introduced along a rotor blade and fastened to the shroud of the rotor blade by a deformation of the balancing weight; in the present example, by a deformation of the middle portion.

As is apparent from FIGS. 1 and 3, first fastening portion 16 is formed in a way that allows balancing weight 18 to be secured in radial direction RD, circumferential direction CD and axial direction AD. In second position thereof relative to first fastening portion 16, second fastening portion 24 additionally secures the balancing weight in axial direction AD and in radial direction RD. Thus, balancing weight 18 is securely installed on shroud 12.

FIG. 4 shows an illustration similar to that of FIG. 3; in addition to second fastening portion 24, which is likewise illustrated here in the second position relative to first fastening portion 16, balancing weight 18 featuring a securing portion 30. Additional securing portion 30 constitutes a securing in axial direction AD and rests against axial trailing edge 28 of shroud 12. In the example of FIG. 4, securing portion 30 and second fastening portion 24 form two side portions that extend slightly obliquely relative to each other starting from middle portion 22.

FIG. 5 shows an illustration similar to that of FIG. 4; in the case of balancing weight 18, securing portion 30 and second fastening portion 24 having a continuous design along trailing edge 28 of shroud 12. In this example, securing portion 30 also serves as securing in axial direction AD.

In FIGS. 4 and 5, balancing weight 18 may likewise feature a twisted region 26 in an uninstalled state, analogously to the balancing weight in FIG. 2. Alternatively, in the case of the balancing weights of FIGS. 4 and 5, it may be considered that only second fastening portion 24 is bent downwardly in the first relative position and, in the case of installation, bent correspondingly upwardly.

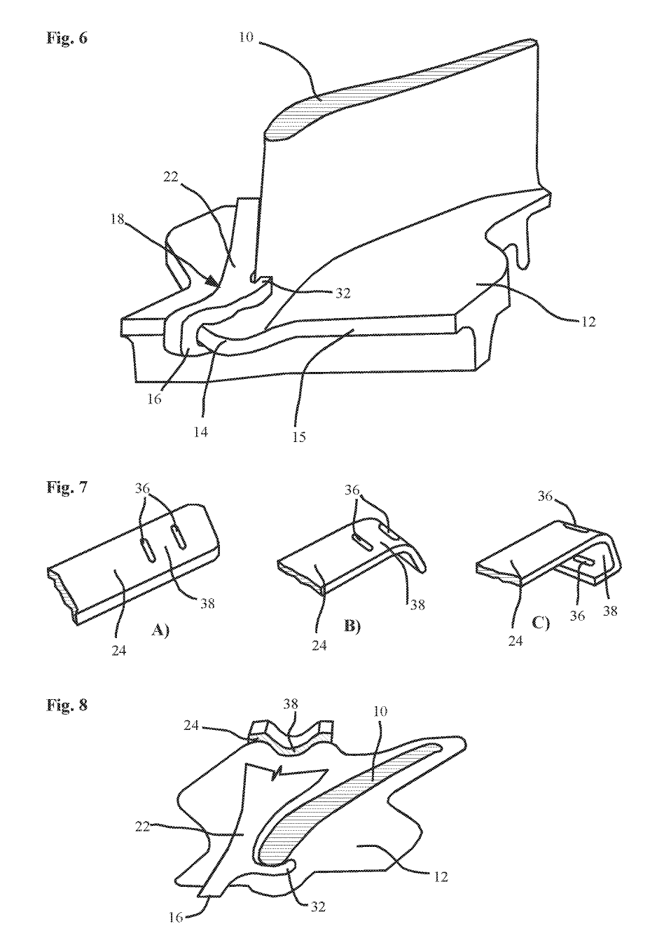

FIG. 6 shows an illustration similar to that of FIG. 1; adjoining first fastening portion 16 on balancing weight 18, a hook-on portion 32 (blade coupling portion) being provided that is positioned in the region of an axial leading edge of rotor blade 10. This hook-on portion 32 provides securing in axial direction AD and circumferential direction CD, while first fastening portion 16 is used for securing balancing weight 18 in axial direction AD and radial direction RD. In this embodiment, first fastening portion 16 is bent around leading edge 15 of the shroud and not looped around projection 14, as in FIG. 1.

FIG. 7 shows an alternative second fastening portion 24 of a balancing weight. In a first position thereof relative to first fastening portion, second fastening portion is essentially planar in accordance with FIG. 7A. The second fastening portion features elongated holes or slots 36 that extend transversely to the longitudinal extent thereof If a balancing weight having such a second fastening portion 24 is attached to the shroud of a rotor blade, the second fastening portion may be deformed or bent over in the area of elongated holes 36 once the balancing weight is introduced, and the first fastening portion is hooked on, allowing it to be bent around axial trailing edge (28) (FIG. 1, 3, 4, 5) of the shroud. The bending process is illustrated step by step in FIGS. 7B and 7C. In the region of elongated holes 36, the process of deforming or bending second fastening portion 24 is simplified due to the structural weakening of the otherwise strip-type fastening portion 24. As illustrated in FIG. 7C, second fastening portion 24 has been bent over or deformed twice in the second relative position. Thus, second fastening portion assumes a different relative position than in first relative position (FIG. 7A).

A web 38 is formed between the two elongated holes 36. In accordance with the illustration of FIG. 8, this web 38 may be adapted to the contour along an axial trailing edge 28 of the shroud. In the illustrated example, web 38 is deformed in axial direction AD toward the trailing edge of shroud 12, allowing it to rest against the multiply curved contour of the shroud. This makes it possible to form a type of interlocking connection. It should be appreciated that second fastening portion in FIG. 8 is merely depicted as a stylized sectional view to provide a better illustration of deformed web 38. It is clear that middle portion 22 is actually joined to second fastening portion 24, even when this is not shown in FIG. 8. In the axially leading region thereof, balancing weight 18 of FIG. 8 has a design similar to that of FIG. 6 and features a hook-on portion 32.

Balancing weight 18 presented here generally has a type of metallic strip design; as is apparent in FIG. 2, this strip being bent or deformed in different directions, so that the various portions are formed that are then used for mounting on the shroud.

The specific embodiments of balancing weight 18 shown with reference to FIG. 1 through 8, in particular of the various embodiments of fastening portions 16, 24 or of the further portions, such as securing portion 30 or hook-on portion 32 or middle portion 22, with or without twisted region 26, may be combined with one another in any way desired. Thus, for example, a first fastening portion 16 shown in FIG. 1, that is hooked onto a projection 14 of shroud 12, may feature a second fastening portion 24 in accordance with FIG. 7. Every combination that is derivable from the figures leads to a further specific embodiment of the balancing weight according to the present invention, even when all possible combinations are not explicitly shown.

The balancing weight presented here makes possible altogether a simple mounting of the balancing weight along a rotor blade and on the shroud of this one rotor blade; it being necessary to deform the middle portion or/and the second fastening portion, respectively, for final completion of the fastening to bring the second fastening portion into the second position thereof relative to the first fastening portion.

### LIST OF REFERENCE NUMERALS

10 rotor blade

12 shroud

14 projection

16 first fastening portion

18 balancing weight

20 unattached end

22 middle portion

24 second fastening portion

26 twisted region

28 axial trailing edge

30 securing portion

32 hook-on portion

34 axial leading edge rotor blade

36 elongated hole

38 web

1-10. (canceled)

11. A balancing weight for a rotor blade of a turbine stage of a gas turbine comprising:
a first bent fastening portion couplable to an axial leading edge of a shroud of a rotor blade;
a second fastening portion couplable to an axial trailing edge of the shroud; and
a middle portion joining the first fastening portion and the second fastening portion;
the second fastening portion assuming a first position relative to the first fastening portion prior to a mounting of the balancing weight on the rotor blade, and a second position relative to the first fastening portion subsequently to the mounting of the balancing weight on the rotor blade; in the second relative position, the middle portion or the second fastening portion being deformed.

12. The balancing weight as recited in claim 11 wherein the middle portion or the second fastening portion is plastically deformed in the second relative position.

13. The balancing weight as recited in claim 11 wherein the first fastening portion is bent to be hookable onto the axial leading edge of the shroud and, in a hooked-on state, is secured to the shroud at least in a radial and in a circumferential direction of the gas turbine.

14. The balancing weight as recited in claim 11 wherein the balancing weight is a strip-type metal element; the strip-type metal element having a plurality of bent regions along a longitudinal extent from a first end to a second end.

15. The balancing weight as recited in claim 14 wherein, in relation to the first relative position of the second fastening portion, the middle portion has a torsion portion where the strip-type metal element is twisted about the longitudinal axis thereof in a first rotational direction.

16. The balancing weight as recited in claim 15 wherein the strip-type metal element is twisted about the longitudinal axis in a first rotational direction by about 90°.

17. The balancing weight as recited in claim 15 wherein, in relation to the second relative position of the second fastening portion, the middle portion is twisted about the longitudinal axis of the strip in a second rotational direction that opposes the first rotational direction in a way that flattens the torsion portion.

18. The balancing weight as recited in claim 11 wherein the second fastening portion has a plurality of elongated openings spaced at regular intervals, starting from an unattached end of the second fastening portion.

19. The balancing weight as recited in claim 18 wherein the elongated openings extend parallel to a bending axis, about which the second fastening portion is plastically deformed in the second relative position.

20. The balancing weight as recited in claim 11 wherein, adjoining the first fastening portion is a blade coupling portion configured to be couplable to a leading edge of the rotor blade.

21. An aircraft gas turbine comprising the balancing weight as recited in claim 11.

22. A rotor blade ring of a turbine stage of a gas turbine, the rotor blade ring comprising:
a plurality of circumferentially adjacently disposed rotor blades, the rotor blades, at radially outer ends thereof, have a respective shroud segment having an axially leading shroud edge and an axially trailing shroud edge; and
a balancing weight being disposed on at least one rotor blade on the shroud segment thereof, the balancing weight including a first bent fastening portion coupled to the axially leading shroud edge, a second fastening portion coupled to the axially trailing shroud edge, and a middle portion joining the first bent fastening portion and the second fastening portion, the second fastening portion assuming a first position relative to the first fastening portion prior to a mounting of the balancing weight on the rotor blade, and a second position relative to the first fastening portion subsequently to the mounting of the balancing weight on the rotor blade; in the second relative position, the middle portion or the second fastening portion being deformed.

23. The rotor blade ring as recited in claim 22 wherein the middle portion or the second fastening portion is plastically deformed in the second relative position.

24. A method for attaching a balancing weight to a shroud segment of a rotor blade of a rotor blade ring of a turbine stage of a gas turbine, the method comprising the steps:
providing a balancing weight having a first bent fastening portion, a second fastening portion, and a middle portion joining the first bent fastening portion and the second fastening portion;
introducing the first bent fastening portion and the middle portion between two adjacent rotor blades of the rotor blade ring in a direction opposite a flow direction of the gas turbine;
positioning the first bent fastening portion on an axially leading edge of the shroud segment and coupling the first bent fastening portion to the leading edge;
deforming the second fastening portion or the middle portion; and
allowing the second fastening portion to be coupled to an axially trailing edge of the shroud segment.

25. The method as recited in claim 24 wherein the coupling includes hooking the first bent fastening portion on the leading edge.
